(19) United States
(12) Patent Application Publication
(10) Pub. No.: US 2016/0049676 A1
(43) Pub. Date: Feb. 18, 2016

(54) APPARATUS AND METHOD FOR PRODUCING FUEL CELL STACK

(71) Applicants: Hyundai Motor Company, Seoul (KR); Kia Motors Corporation, Seoul (KR)

(72) Inventors: Namgu Lee, Yongin (KR); Sanghyun Cho, Hwaseong (KR); Joook Park, Ulsan (KR)

(73) Assignees: Hyundai Motor Company; Kia Motors Corporation

(21) Appl. No.: 14/556,115

(22) Filed: Nov. 29, 2014

(30) Foreign Application Priority Data
Aug. 12, 2014 (KR) 10-2014-0104345

(51) Int. Cl. H01M 8/10; B25J 11/00

(52) U.S. Cl. CPC H01M 8/1004; B25J 11/005; H01M 2008/1095; H01M 2300/0082; Y10S 901/40

(57) ABSTRACT

Disclosed is a method for producing a fuel cell stack. The method for producing a fuel cell stack includes: (a) inserting one or more thin paper between a plurality of GDLs; (b) supplying, by a transfer robot, the GDLs of step (a) to a GDL supply part and supplying, by the transfer robot, MEAs to an MEA supply part; (c) adsorbing, by the transfer robot, the GDL and the thin paper, respectively, one by one; (d) removing, by a thin paper eliminator, the thin paper of step (c); (e) supplying the GDL and the MEA from which the thin paper is removed to a compressor to compress the GDL and the MEA so as to form an integrated part; and (f) cutting the integrated part formed in step (e) to a predetermined size by a trimming press.

### CROSS-REFERENCE TO RELATED APPLICATION

This application claims priority to and the benefit of Korean Patent Application No. 10-2014-0104345 filed in the Korean Intellectual Property Office on Aug. 12, 2014, the entire contents of which are incorporated herein by reference.

### TECHNICAL FIELD

The present invention relates to an apparatus and a method for producing a fuel cell stack which may improve production efficiency of the fuel cell stack.

### BACKGROUND

Generally, the development of an automated stacking technology that may provide precise quality and performance of a fuel cell has been required.

For example, the stacking needs to be performed so that final alignment between stacked materials maintains flatness of about 1.5 mm during stacking about 1000 sheets of electrochemical materials all having a large deviation in mechanical properties and tolerance in series. When the stacking alignment of the fuel cell stack is mismatched, the performance of the fuel cell may deteriorate and thus a vehicle using the fuel cell may not be driven properly.

Meanwhile, in the related arts, during the production of the fuel cell stack, MEAs and GDLs which are components of the fuel cell stack may be vacuum adsorbed and transferred to the stacked position by a transfer robot.

The GDLs are made of a porous material having high air permeability, and when the GDLs are vacuum adsorbed and transferred by the transfer robot, an adsorption pressure may be applied to the GDLs such that each of the GDLs may not be individually adsorbed and transferred.

The above information disclosed in this Background section is only for enhancement of understanding of the background of the invention and therefore it may contain information that does not form the prior art that is already known in this country to a person of ordinary skill in the art.

### SUMMARY OF THE INVENTION

In a preferred aspect, the present invention provides apparatuses and methods for producing a fuel cell stack which may have advantages of adsorbing and transferring GDLs using a transfer robot.

In an exemplary embodiment of the present invention, a method for producing a fuel cell stack may include: (a) inserting one or more thin papers between a plurality of GDLs; (b) supplying, by a transfer robot, the GDLs of step (a) to a GDL supply part and supplying, by the transfer robot, MEAs of step (a) to an MEA supply part; (c) adsorbing, by the transfer robot, the GDL and the thin paper, respectively, one by one; (d) removing, by a thin paper eliminator, the thin paper of step (c); (e) supplying the GDL and the MEA from which the thin paper is removed to a compressor to compress the GDL and the MEA so as to form an integrated part; and (f) cutting the integrated part compressed in step (e) to a predetermined size by a trimming press.

In step (a), the thin paper may be formed of a non-porous material. For instance, materials that suitably used as a “paper” as disclosed herein may include conventional paper or felt. Thus, the term “paper” used in this specification should be understood to include felt. References herein to “thin” paper secondly indicate the paper material having a thickness less than that of GTL. Also, length and width of thin paper as used herein suitably may be smaller than or of equal size with GDL.

The plurality of GDLs may include a plurality of upper GDLs and a plurality of lower GDLs, and step (a) may further include: (a-1) inserting the thin paper between the upper GDLs; and (a-2) inserting the thin paper between the lower GDLs.

In step (c), the transfer robot may be provided with a pressure sensor to determine a normal adsorption state.

The thin paper eliminator may be an adsorber configured to adsorb a side of the thin paper.

The compressor may be a hot press configured to compress the GDL and the MEA at a high temperature and a high pressure to form the integrated part.

In an exemplary embodiment of the present invention, also provided is an apparatus for producing a fuel cell stack. The apparatus may include: an MEA supply part configured to supply MEAs; a GDL supply part configured to be disposed on one side of the MEA supply part and supply a plurality of GDLs having one or more thin paper inserted between the GDL layers; a transfer robot configured to adsorb and transfer the GDL and the thin paper together; a thin paper eliminator configured to eliminate the thin paper adsorbed by the transfer robot; a compressor configured to be provided with the GDL and the MEA and compress the GDL and the MEA to form an integrated part; and a trimming press configured to cut the integrated part formed by the compressor into a predetermined size.

The thin paper may be formed of a non-porous material.

The transfer robot may be provided with a pressure sensor configured to determine whether an adsorption pressure is normal.

The compressor may be a hot press configured to compress the GDL and the MEA at a high temperature and a high pressure to form an integrated part.

The thin paper eliminator may be an adsorber configured to adsorb a side of the thin paper.

Further provided are fuel cell stacks that may be obtained by the method as disclosed herein

According to various exemplary embodiments of the present invention, the GDLs may be efficiently transferred by inserting the thin paper between the GDLs and adsorbing and transferring one GDL and one sheet of thin paper using the transfer robot.

Further, the thin paper may be eliminated automatically without any interruption by installing the thin paper eliminator which eliminates the thin paper inserted between the GDLs, thereby improving the operation efficiency.

### BRIEF DESCRIPTION OF THE DRAWINGS

FIG. 1 illustrates an exemplary apparatus for producing a fuel cell stack according to an exemplary embodiment of the present invention.

FIG. 2 illustrates exemplary main parts when one or more thin papers are inserted between GDLs according to an exemplary embodiment of the present invention.

FIG. 3 illustrates an exemplary operation of main parts when the GDL and the thin paper are adsorbed by a transfer robot according to an exemplary embodiment of the present invention.

FIG. 4 illustrates an exemplary process when thin paper is eliminated by a thin paper eliminator according to an exemplary embodiment of the present invention.

FIG. 5 i illustrates an exemplary method for producing a fuel cell stack according to an exemplary embodiment of the present invention.

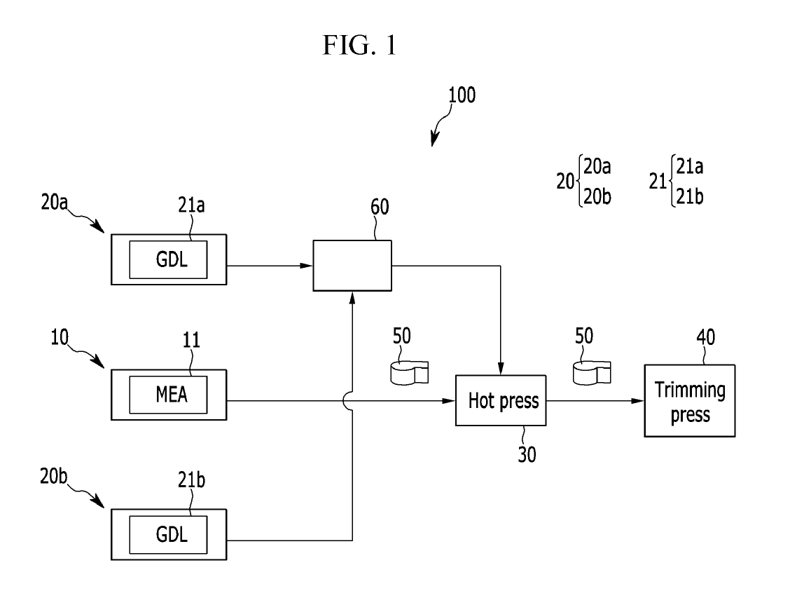

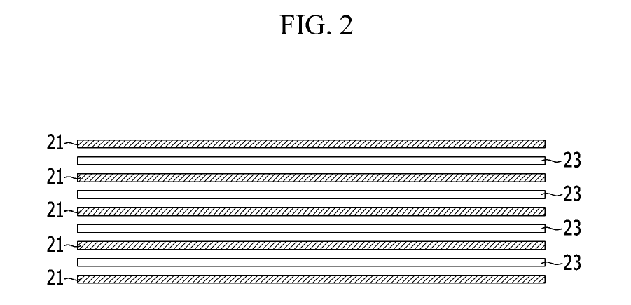

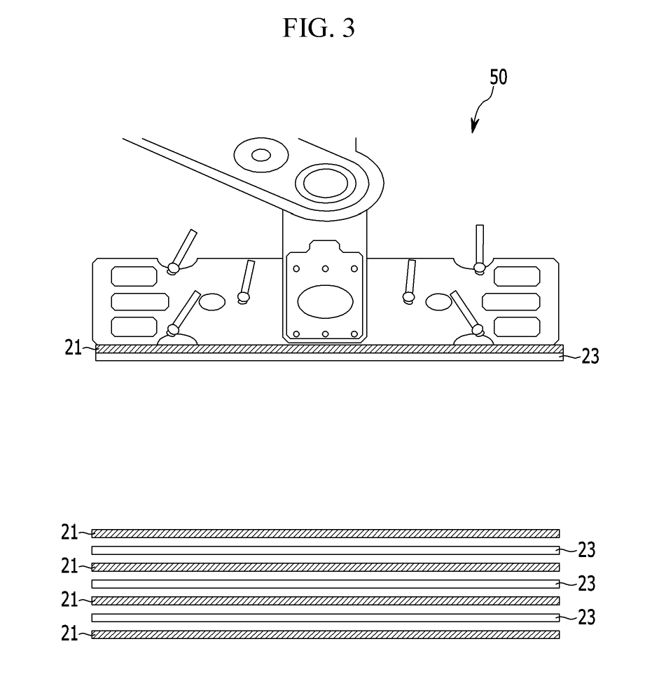

Reference numerals set forth in the FIGS. 1-5 include reference to the following elements as further discussed below:

| | | | |
|---|---|---|---|
| 10 | MEA supply part | 11 | MEA |
| 20 | GDL supply part | 21 | GDL |
| 21a, 21b | GDL | 30 | Hot press |
| 40 | Trimming press | 50 | Transfer robot |
| 60 | Thin paper eliminator | | |

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, exemplary embodiments of the present invention will be described in detail so as to be easily practiced by a person skilled in the art to which the present invention pertains, with reference to the accompanying drawings. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

FIG. 1 illustrates an exemplary apparatus for producing an exemplary fuel cell stack according to an exemplary embodiment of the present invention.

As illustrated in FIG. 1, an apparatus 100 for producing a fuel cell stack may include: an MEA supply part 10 configured to supply MEAs 11; a GDL supply part 20 configured to be disposed on one side of the MEA supply part 10 and supply a plurality of GDLs 21 having one or more thin papers 23 inserted between the GDLs; a compressor 30 configured to compress the MEAs 11 and the GDLs 21 to form an integrated part at a high temperature and a high pressure when the MEAs 11 and the GDLs 21 are stacked; a trimming press 40 configured to cut the integrated part formed by the compressor 30 into a predetermined size; a transfer robot 50 configured to sequentially transfer the MEAs 11 and the GDLs 21 to the MEA supply part 10, the GDL supply part 20 and the hot press 30, and adsorb and transfer the integrated part compressed by the compressor 30 to the trimming press 40; and a thin paper eliminator 60 configured to eliminate the thin paper 23 from the GDLs 21 adsorbed by the transfer robot 50.

Hereinafter, the case in which the compressor is a hot press compressing the GDL and the MEA at a high temperature and a high pressure will be exemplarily described. The compressor may be, but not limited to, the hot press, and any compressor generally used in the art which compresses the GDL and the MEA may be used. Hereinafter, the compressor and the hot press may be referred with the reference numeral 30.

The MEA supply part 10 may be mounted to supply the MEAs 11, and may be mounted to sequentially supply the MEAs 11 from an upper part of the apparatus when which the MEAs 11 are stacked. Particularly, the stacked MEAs 11 sequentially may rise step by step each time when stacked MEAs 11 are drawn out one by one, and thus the MEAs 11 may be continuously supplied.

The GDL supply part 20 may be mounted adjacent to the MEA supply part 10 and may be mounted to supply the GDLs 21. The GDL supply part 20 may supply a lower GDL 21a and an upper GDL 21b to the hot press 30. The GDL supply part 20 may be mounted to sequentially supply the GDLs 21 when the GDLs 21 are stacked. Particularly, the stacked GDLs 21 sequentially may rise step by step each time the stacked GDLs 21 are drawn out one by one, and thus the GDLs 21 may be continuously supplied. As described herein, reference numeral 20a represents a lower GDL supply part, and reference numeral 20b represents an upper GDL supply part.

One or more thin papers 23 may be inserted between the plurality of GDLs 21. According to an exemplary embodiment of the present invention, the thin paper 23 may be formed of a non-porous material in which any penetrating portion may not exist. The thin paper 23 may be formed of the non-porous material to prevent an adsorption pressure being applied to the GDL 21 from penetrating the thin paper 23 when the adsorption pressure of the transfer robot 50 is applied to the GDL 21. Accordingly, the transfer robot 50 may adsorb one GDL 21 and one thin paper 23 each time.

The transfer robot 50 may be provided with a pressure sensor. When it is determined that the adsorption pressure of the GDL 21 and the thin paper 23 adsorbed by the transfer robot 50 is in an abnormal pressure, the transfer of the transfer robot 50 may be determined to be failed and a failure measure may be rapidly performed.

Meanwhile, before the GDL 21 and the thin paper 23 adsorbed by the transfer robot 50 are transferred to the hot press 30, the thin paper eliminator 60 may eliminate the thin paper 23.

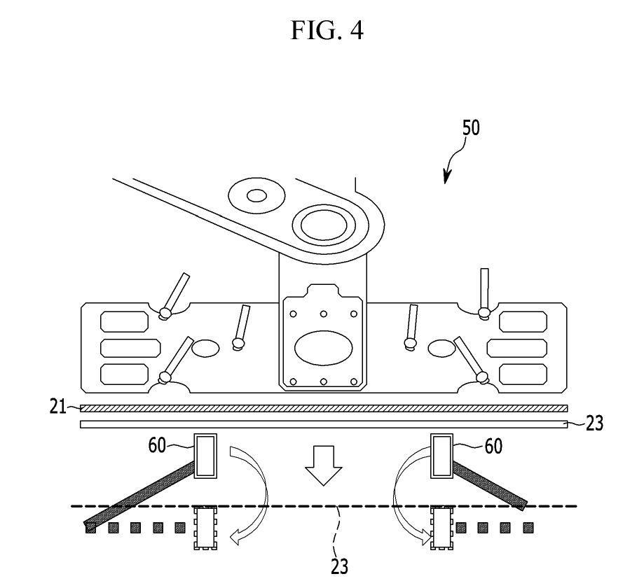

FIG. 4 illustrates a state when the thin paper is eliminated by a thin paper eliminator according to an exemplary embodiment of the present invention.

As illustrated in FIG. 4, the thin paper eliminator 60 may include an adsorber which adsorbs a side portion of the thin paper 23. Accordingly, the thin paper eliminator 60 may be operated to rotate such that the side portion of the thin paper 23 may be adsorbed by the adsorber, thereby removing the thin paper 23 from the GDL 21.

As such, before the GDLs 21 are supplied to the hot press 30 through the GDL supply part 20, the thin paper 23 from one GDL 21 and one thin paper 23 adsorbed by the transfer robot 50 may be eliminated automatically. Accordingly, manually process of eliminating the thin paper by an operator as in the related art may be omitted, and consequently, the operation efficiency may be improved and a repetitive strain injury (RSI) of an operator may be prevented.

The transfer robot 50 may sequentially supply the GDLs 21 and the MEAs 11 to the hot press 30.

The hot press 30 may compress the MEA 11 and the GDL 21 to form an integrated part. Further, the integrated part of the MEA 11 and the GDL 21 may be transferred to the trimming press 40 by the transfer robot 50 and thus the integrated part 11 may be cut at an appropriate size.

The trimming press 40 may be provided with a press mold in which the integrated part is seated to cut the integrated part into a predetermined size. Any driving and cutting methods which are generally used in the art for cutting the integrated part may be used in operating the trimming press 40 without limitation.

As described above, the apparatus 100 for producing a fuel cell stack may easily eliminate the thin paper 23, thereby effectively producing the fuel cell stack.

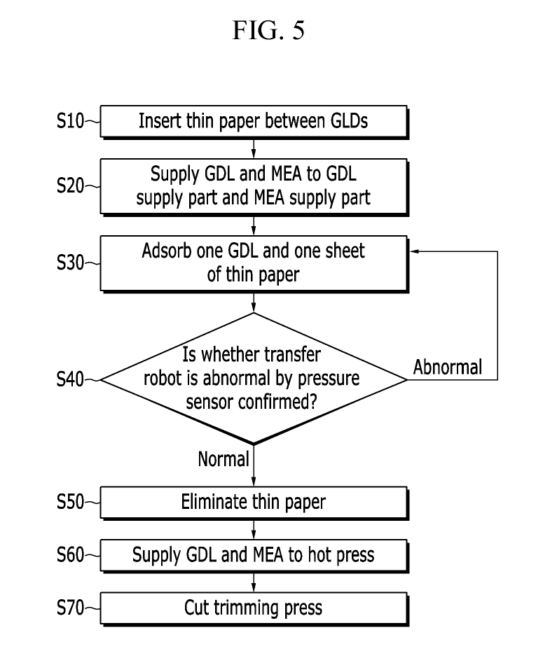

FIG. 5 illustrates an exemplary method for producing a fuel cell stack according to an exemplary embodiment of the present invention. The reference numerals of FIGS. 1 to 4 indicate members having same functions. Hereinafter, as shown in FIG. 5, a method for producing a fuel cell stack according to an exemplary embodiment of the present invention will be described in detail.

In step S10, the thin paper 23 may be inserted between the GDLs 21. Particularly, the thin paper 23 may be formed of a non-porous material. In the step S10, the GDL 21 may include an upper GDL and a plurality of lower GDLs. Accordingly, a process S11 of inserting the thin paper 23 between upper GDLs 21a and a process S12 of inserting the thin paper 23 between lower GDLs 21b may be sequentially performed.

In step S20, the GDL 21 and the MEA 11 of the step S10 may be supplied to the GDL supply part 20 and the MEA supply part 10, respectively, by the transfer robot 50.

In step S30, one GDL 21 and one thin paper 23 inserted between the adjacent GDLs 21 may be adsorbed together by the transfer robot 50. The GDL 21 may be formed of a porous material and the thin paper 23 is formed of a non-porous material. As such, the transfer robot 50 may apply the adsorption pressure to adsorb one GDL 21 and one thin paper 23 together each time.

In step S40, when it is determined by the pressure sensor mounted in the transfer robot 50 that the adsorption pressure of the GDL 21 and the thin paper 23 which are adsorbed by the transfer robot 50 is in a range of abnormal pressure, the transfer of the transfer robot 50 may be determined to be failed and a failure measure may be rapidly performed.

In step S50, the thin paper 23 of the step S30 may be eliminated by the thin paper eliminator 60 (S50). The thin paper eliminator 60 may be operated to rotate such that the side portion of the thin paper 23 may be adsorbed by the adsorber, thereby removing the thin paper 23 from the GDL 21.

In step S60, the GDL 21 and the MEA 11 from which the thin paper 23 is eliminated in the step S50 may be supplied to the hot press 30 and compressed to form the integrated part (S60). According to an exemplary embodiment of the present invention as shown in FIG. 1, the GDL 21 and the MEA 11 may be compressed by the hot press 30, but the compressing method may be limited to the hot press and the like and the hot press 30 may be replaced by a predetermined compressor which may compress the GDL and the MEA.

In step S70, the integrated part formed in the step S60 by the compressor 30 may be cut and trimmed into a predetermined size using the trimming press 40. The trimmed integrated part may be used for producing the fuel cell stack.

Hereinabove, the present invention has been described with reference to the exemplary embodiments illustrated in the drawings. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for producing a fuel cell stack, comprising:
(a) inserting one or more thin papers between a plurality of GDLs;
(b) supplying, by a transfer robot, the GDLs of step (a) to a GDL supply part and supplying, by the transfer robot, MEAs to an MEA supply part;
(c) adsorbing, by the transfer robot, the GDL and the thin paper, respectively, one by one;
(d) removing, by a thin paper eliminator, the thin paper of step (c);
(e) supplying the GDL and the MEA from which the thin paper is removed to a compressor to compress the GDL and the MEA so as to form an integrated part; and
(f) cutting the integrated part formed by the compressor in step (e) into a predetermined size by a trimming press.

2. The method of claim 1, wherein in step (a), the thin paper is formed of a non-porous material.

3. The method of claim 2, wherein the plurality of GDLs include a plurality of upper GDLs and a plurality of lower GDLs, and step (a) includes:
(a-1) inserting the thin paper between the upper GDLs; and
(a-2) inserting the thin paper between the lower GDLs.

4. The method of claim 3, wherein, in step (c), the transfer robot is provided with a pressure sensor to determine a normal adsorption state.

5. The method of claim 1, wherein the thin paper eliminator is an adsorber configured to adsorb a side of the thin paper.

6. The method of claim 1, wherein the compressor is a hot press configured to compress the GDL and the MEA at a high temperature and a high pressure to form an integrated part.

7. An apparatus for producing a fuel cell stack, comprising:
a MEA supply part configured to supply MEAs;
a GDL supply part configured to be disposed on one side of the MEA supply part and supply a plurality of GDLs having one or more thin papers inserted between the GDLs;
a transfer robot configured to adsorb and transfer the GDL and the thin paper together;
a thin paper eliminator configured to eliminate the thin paper adsorbed by the transfer robot;
a compressor configured to be provided with the GDL and the MEA and compress the GDL and the MEA to form an integrated part; and
a trimming press configured to cut the integrated part formed by the compressor into a predetermined size.

8. The apparatus of claim 7, wherein the thin paper is formed of a non-porous material.

9. The apparatus of claim 7, wherein the transfer robot is provided with a pressure sensor configured to determine whether an adsorption pressure is normal.

10. The apparatus of claim 7, wherein the compressor is a hot press configured to compress the GDL and the MEA at a high temperature and a high pressure to form an integrated part.

11. The apparatus of claim 7, wherein the thin paper eliminator is an adsorber configured to adsorb a side of the thin paper.

12. A fuel cell stack obtained by the method of claim 1.
